(19) United States
(12) Patent Application Publication
(10) Pub. No.: US 2025/0023289 A1
(43) Pub. Date: Jan. 16, 2025

(54) INTEGRATED SEALED ELECTRICAL CONNECTOR

(71) Applicant: Amphenol East Asia Electronic Technology (Shenzhen) Co., Ltd., Shenzhen (CN)

(72) Inventors: Zhimin Qin, Shenzhen (CN); Zhuqi Lu, Shenzhen (CN)

(73) Assignee: Amphenol East Asia Electronic Technology (Shenzhen) Co., Ltd., Shenzhen (CN)

(21) Appl. No.: 18/768,291

(22) Filed: Jul. 10, 2024

(30) Foreign Application Priority Data
Jul. 10, 2023 (CN) 202321801117.0
Aug. 18, 2023 (CN) 202311045011.7
Aug. 18, 2023 (CN) 202322241812.2

(51) Int. Cl. H01R 13/52; H01R 13/26; H01R 13/405; H01R 43/00

(52) U.S. Cl. CPC H01R 13/5202; H01R 13/26; H01R 13/405; H01R 43/005

(57) ABSTRACT

An integrated sealed electrical connector. The connector includes a housing holding conductive elements in a row. The housing has a body, a tongue extending from the body in a mating direction, and a bracket extending from a side of the body. Each conductive element has a mating portion held by the tongue. A frame is partially embedded in and partially disposed outside the housing to, for example, mount to a board. The frame and bracket have aligned holes configured for receiving, e.g., a screw to mount to the board. Some conductive elements are configured for transmitting power and have a uniform thickness; and others are configured for transmitting signals and have a smaller thickness at the mating portion. Front and rear seals are attached to rough surfaces of the housing and conductive elements, respectively. Such techniques enable a securely sealed hybrid connector capable of reliable mating/mounting within a small space.

### CROSS-REFERENCE TO RELATED APPLICATIONS

This application claims priority to and the benefit of Chinese Patent Application No. 202322241812.2, filed on Aug. 18, 2023. This application also claims priority to and the benefit of Chinese Patent Application No. 202311045011.7, filed on Aug. 18, 2023. This application also claims priority to and the benefit of Chinese Patent Application No. 202321801117.0, filed on Jul. 10, 2023. The contents of these applications are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time. For example, portable electronic devices often include USB Type-C connectors for various purposes such as charging and/or exchanging data with another electronic device by connecting the USB connector with a USB plug connector.

Some USB connectors are water resistant. These connectors may include seals that block water from outside the computer enclosure from entering the computer enclosure through the opening left for the connector.

### BRIEF SUMMARY

Aspects of the present disclosure relate to integrated sealed electrical connectors.

Some embodiments relate to a terminal assembly. The terminal assembly may comprise a plurality of first terminals aligned in a row direction, each of the plurality of first terminals having a same thickness in a vertical direction perpendicular to the row direction along a length of the first terminal; and a plurality of second terminals aligned with the plurality of first terminals in the row direction, each of the plurality of second terminals comprising a portion with a smaller thickness in the vertical direction than a rest of the second terminal.

Optionally, the plurality of first terminals are configured for transmitting power; and the plurality of second terminals are configured for transmitting signals.

Optionally, the terminal assembly is configured according to the USB-C standard; each of the plurality of first terminals is configured to convey a current in a range of 5 A to 10 A; and each of the plurality of second terminals is configured to transmit signals at a speed in a range of 5 Gbps to 80 Gbps per second.

Optionally, each of the plurality of first terminals has a first thickness in a range of 0.1 mm to 0.35 mm; and for each of the plurality of second terminals: the portion with the smaller thickness has a thickness in a range of 0.01 mm to 0.10 mm, and the rest of the second terminal has a thickness in a range of 0.1 mm to 0.25 mm.

Optionally, each of the plurality of second terminals comprises a mating portion configured for mating with another component, and the mating portion of the second terminal comprises the portion with the smaller thickness.

Optionally, each of the plurality of second terminals comprises a tail portion opposite the mating portion and configured for surface mounting to a board.

Optionally, each of the plurality of first terminals and the plurality of second terminal comprises a plating layer of one or more of platinum, rhodium-ruthenium, and palladium.

Optionally, each of the plurality of first terminals and the plurality of second terminals comprises a rough portion adjacent the tail portion, and the rough portion of the respective terminal has a surface roughness higher than other portions of the respective terminal such that a sealing member can be attached to the rough portions of the terminals.

Some embodiments relate to an electrical connector. The electrical connector may comprise a housing comprising a body, a tongue extending from the body in a mating direction, and a bracket extending from a side of the body; a plurality of conductive elements held by the housing in a row, each of the plurality of conductive elements comprising a mating portion held by the tongue of the housing and a tail portion extending out of the housing; and a frame comprising a first portion embedded in the body of the housing, a second portion disposed outside the housing, and a third portion embedded in the bracket of the housing.

Optionally, the housing comprises a groove disposed between the body and the tongue and having a surface with a roughness higher than other portions of the housing; and a sealing member is attached to the surface of the groove of the housing.

Optionally, the groove is disposed along a circumferential portion of the housing.

Optionally, the bracket is a first bracket extending from a first side of the body of the housing; the housing comprises a second bracket extending from a second side of the body of the housing opposite the first side; and the sealing member is disposed between the first and second brackets.

Optionally, each of the first and second brackets comprises a hole; and the third portion of the frame comprises holes aligned with the holes of the first and second brackets.

Optionally, the sealing member is a first sealing member; the body of the housing comprises a cavity; and the electrical connector comprises a second sealing member disposed in the cavity of the body of the housing and attached to portions of the plurality of conductive elements passing the cavity of the body of the housing.

Optionally, the portions of the plurality of conductive elements passing the cavity of the body of the housing have surfaces with a roughness higher than other portions of respective conductive elements.

Optionally, the plurality of conductive elements comprise first terminals each having a uniform thickness along its length and second terminals having a smaller thickness at the mating portion than the tail portion.

Some embodiments relate to a method for manufacturing an electrical connector. The method may comprise providing a plurality of conductive elements; molding an assembly housing over at least portions of the plurality of conductive elements; disposing a frame on the assembly housing; and molding a connector housing over a portion of the frame.

Optionally, the plurality of conductive elements is a first plurality of conductive elements aligned in a first row; and the method comprises disposing a second plurality of conductive elements in a second row parallel to the first row before disposing the frame on the assembly housing.

Optionally, the connector housing comprises a groove around a circumferential direction of the connector housing; and the method comprises: roughening a surface of the groove of the housing, and forming a sealing member in the groove of the housing.

Optionally, the sealing member is a front sealing member; the housing comprises a cavity through which the plurality of conductive elements pass; and the method comprises forming a rear sealing member in the cavity of the housing and around the plurality of conductive elements pass therethrough.

Some embodiments relate to a terminal assembly. The terminal assembly may include: a first terminal configured to have a first thickness and transmit power, and a second terminal configured to transmit a signal, at least a portion of each second terminals is configured to have a second thickness less than the first thickness.

Optionally, the first thickness is in the range of 0.1 mm to 0.35 mm.

Optionally, the second terminal is configured to have a reduced thickness portion subjected to a thinning process, and the reduced thickness portion has a thickness as the second thickness; the second terminal is configured to have a thickness in the range of 0.1 mm to 0.25 mm at portions other than the reduced thickness portion; and the reduced thickness portion is configured to have a reduced thickness in the range of 0.01 mm to 0.10 mm.

Optionally, the first terminal comprises a mating portion and a tail portion, the second terminal comprises a mating portion and a tail portion, the mating portion of the second terminal comprises the reduced thickness portion, and the mating portion of the first terminal is configured to have a uniform thickness.

Optionally, the first terminal is configured to be able to convey a current in the range of 5 A to 10 A; and the second terminal is configured to be able to transmit signals at a speed in the range of 5 Gbps to 80 Gbps per second.

Optionally, each of the first terminal and the second terminal is provided with a corrosion-resistant plating layer, the material of the plating layer may be any of platinum, rhodium-ruthenium, and palladium.

Some embodiments relate to an electrical connector. The electrical connector may include a housing and the terminal assembly; a plurality of the first terminal and a plurality of the second terminal are provided and form two rows of terminals arranged above each other in a height direction of the electrical connector; and the housing is sleeved outside the two rows of terminals for fixing the two rows of terminals.

Optionally, one row of terminals of the two rows of terminals is configured as a first row of electrically conductive elements formed by some of the plurality of first terminals and some of the plurality of second terminals, and the other row of terminals of the two rows of terminals is configured as a second row of electrically conductive elements formed by the others of the plurality of first terminals and the others of the plurality of the second terminals, the first row of electrically conductive elements and the second row of electrically conductive elements are disposed opposite to each other in the height direction of the electrical connector.

Optionally, at least some of the plurality of second terminals forming the first row of electrically conductive elements and at least some of the plurality of second terminals forming the second row of electrically conductive elements are configured to have reduced thickness portions subjected to a thinning process, and the second terminals forming the first row of electrically conductive elements and having the reduced thickness portion and the second terminals forming the second row of electrically conductive elements and having the reduced thickness portion are aligned with each other in the height direction.

Optionally, the terminal assembly comprises a shield located between the first row of electrically conductive elements and the second row of electrically conductive elements, the shield is spaced apart from the first row of electrically conductive elements and the second row of electrically conductive elements in the height direction, respectively, by a predetermined distance.

Optionally, the housing comprises a terminal assembly housing, the terminal assembly housing defining a housing portion for accommodating the first terminal and the second terminal, the tail portion of the first terminal and the tail portion of the second terminal are molded into the housing portion of the terminal assembly housing by injection molding.

Optionally, the shield is molded into the housing portion of the terminal assembly housing by injection molding together with the tail portions of the first terminals and the tail portions of the second terminals forming the first row of electrically conductive elements and the second row of electrically conductive elements.

Optionally, the electrical connector further comprises a first sealing member; and a groove is provided along a circumferential portion of the housing, and the first sealing member is provided inside the groove.

Optionally, the electrical connector further comprises a second sealing member; and the housing is provided with a cavity having a hole depth direction perpendicular to a top surface of the terminal assembly, and the second sealing member is provided inside the cavity.

Optionally, the housing is provided with a first rough portion at a groove bottom of the groove, for increasing an adhesion force between the first sealing member and the housing; and the terminal assembly is provided with a second rough portion in a region where the cavity is projected on the terminal assembly in the hole depth direction, for increasing an adhesion force between the second sealing member and the terminal assembly.

Optionally, the first sealing member is an elastically deformable member, the first sealing member is configured to elastically deform when the first sealing member contacts with a mounting portion of an electronic device adapted to the electrically connector, and to form an interference fit with the mounting portion of the electronic device.

Optionally, the first sealing member is configured to have an annular shape extending continuously in a circumferential direction around a mating end of the housing, and the first scaling member is configured to have an attachment surface forming a positive fit with the groove of the housing.

Optionally, the second sealing member is configured to have a substantially square shape, and the second sealing member is configured to have an attachment surface forming a positive fit with the cavity of the housing.

Optionally, the electrical connector further comprises a frame; the frame has a first portion embedded in the housing, a second portion disposed outside of the housing, and a third portion formed by extending from both sides of the first portion; and the housing is formed with a bracket extending from both sides thereof, the third portion of the frame is embedded in the bracket.

Optionally, an accommodating portion for accommodating the first portion is provided in the vicinity of a tail end of the terminal assembly housing such that the frame is positioned in a predetermined position relative to the terminal assembly housing and the terminal assembly.

Optionally, a central portion of the housing connecting the bracket is formed with the cavity, and before the second sealing member is arranged in the cavity, a corresponding ones of the first terminals and the second terminals is exposed through the cavity.

Optionally, a mating portion of the housing is formed with the groove at a predetermined position from the central portion.

Some embodiments relate to a method for manufacturing an electrical connector. The method include Step 01): providing a plurality of first terminals and a plurality of second terminals, and forming a first row of electrically conductive elements by some of the plurality of first terminals and some of the plurality of second terminals, and forming a second row of electrically conductive elements by others of the plurality of first terminals and others of the plurality of second terminals; Step 02): providing a shield; Step 03): placing the first row of electrically conductive elements and the shield into a first injection mold and performing a first injection molding to form a first molding member; Step 04): assembling the second row of electrically conductive elements onto the first molding member and positioning the second row of electrically conductive elements in a predetermined position relative to the first molding member; and Step 05): providing a frame and positioning the frame in a predetermined position relative the first molding member and the second row of electrically conductive elements, placing the frame, the second row of electrically conductive elements, and the first molding member into a second injection mold, and performing a second injection molding to form a second molding member, the second molding member comprising a housing.

Optionally, in the Step 03), a mounting slot for assembling the second row of electrically conductive elements is integrally molded on a side of the first molding member opposite to a side of the shield positioning the first row of electrically conductive elements.

Optionally, the mounting slot comprises a plurality of first slots close to a mating end side of the first molding member, a plurality of third slots close to a tail end side of the first molding member, and a plurality of second slots provided between the plurality of first slots and the plurality of third slots in a mating direction of the electrical connector, each of the plurality of first slots, each of the plurality of second slots and each of the plurality of third slots are aligned with one another in a one-to-one correspondence in the mating direction of the electrical connector, for housing and positioning a corresponding one of the terminals forming the second row of electrically conductive elements.

Optionally, the first molding member formed in the Step 03) comprises a terminal assembly housing, with an accommodating portion provided on a side of the terminal assembly housing on which the first row of electrically conductive elements is arranged and near a tail end of the first molding member.

Optionally, in the Step 05), providing a frame comprises configuring the frame with: a first portion as a central portion of the frame; a second portion extending from the first portion in the mating direction toward a tail end of the electrical connector; and a third portion overhanging from both sides of the first portion in a width direction of the electrical connector along a height direction of the electrical connector, the third portion is formed with an L-shaped stepped portion having legs parallel to the first portion, the second portion is accommodated in the accommodating portion to position the frame in a predetermined position relative to the first molding member and the second row of electrically conductive elements assembled together in the Step 04).

Optionally, in the Step 05), during performing the second injection molding to form a second molding member, a supporting portion is formed in the vicinity of a tail end of the housing, wherein a groove is formed at a mating side of the supporting portion at a predetermined distance from the supporting portion, and a cavity is formed on two opposite surfaces of the supporting portion in the height direction of the electrical connector.

Optionally, the method further comprises roughening the electrical connector, the groove and the cavity to form a rough portion.

Optionally, the method further comprises: applying an adhesive at the rough portion of the groove and/or at the rough portion of the cavity to form a first sealing member in the groove and/or a second sealing member in the cavity.

Optionally, in the Step 03), the first row of electrically conductive elements is spaced apart from the shield in the height direction of the electrical connector.

Optionally, in the Step 04), the second row of electrically conductive elements is positioned in a predetermined position relative to the first molding member in a manner that the second row of electrically conductive elements is spaced from the first row of electrically conductive elements in the height direction of the electrical connector and that the shield is positioned between the first row of electrically conductive elements and the second row of electrically conductive elements.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of a row of terminals of an electrical connector of FIG. 6, according to some embodiments;

FIG. 2 is a side schematic view of a terminal of the row of terminals of FIG. 1, according to some embodiments;

FIG. 3 is a perspective view of first and second terminals of the row of terminals of FIG. 1, according to some embodiments;

FIG. 4 is a perspective view of a terminal assembly comprising a shield provided between two rows of terminals of the electrical connector of FIG. 6, with a terminal assembly housing hidden, according to some embodiments;

FIG. 5 is a bottom view of an electrical connector, according to some embodiments;

FIG. 6 is a top perspective view of the electrical connector of FIG. 5, according to some embodiments;

FIG. 7 is bottom perspective view of the electrical connector of FIG. 6, according to some embodiments;

FIG. 8 is a partially exploded perspective view of the electrical connector of FIG. 6, according to some embodiments;

FIG. 9 is a perspective view of the electrical connector of FIG. 5 with connector housing hidden, showing a terminal assembly housing and frame, according to some embodiments;

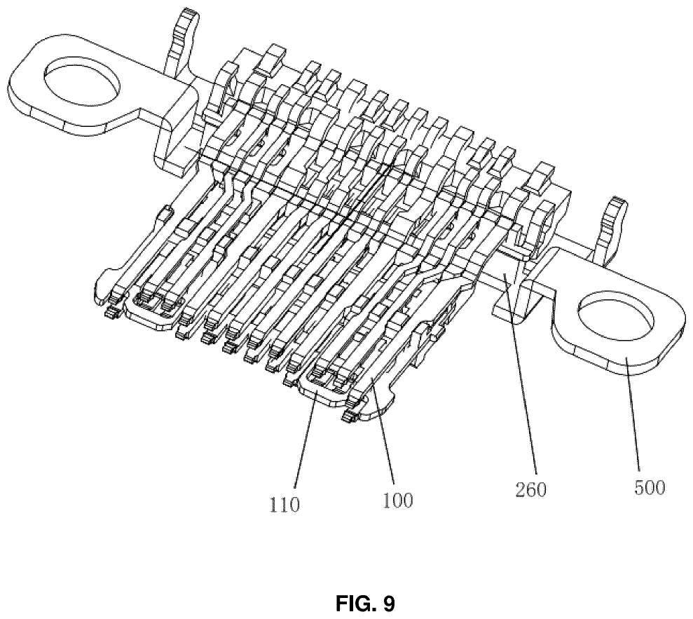

FIGS. 10A and 10 B are top and bottom views of the electrical connector of FIG. 6, respectively, showing a first rough portion and a second rough portion, according to some embodiments;

FIG. 11 is a bottom perspective view of a first row of terminals of the electrical connector of FIG. 6, showing Step 03) of a method of manufacturing the electrical connector, according to some embodiments;

FIG. 12 is a bottom perspective schematic view of first and second rows of terminals of the electrical connector of FIG. 6, showing Step 04) of the method of manufacturing the electrical connector, according to some embodiments;

FIG. 13 is another bottom perspective view of the first and second rows of terminals of FIG. 12, showing Step 04) of the method of manufacturing the electrical connector, according to some embodiments;

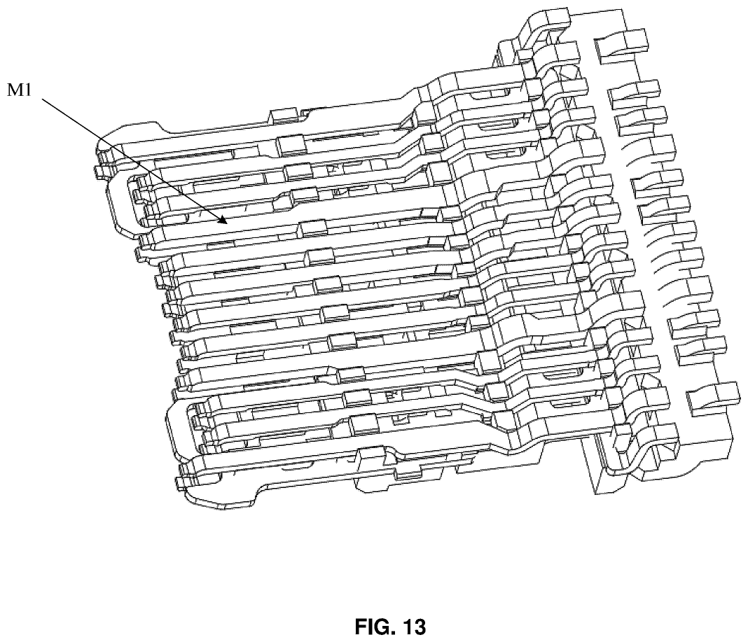

FIG. 14 is a top perspective view of the electrical connector of FIG. 6, showing Step 05) of the method of manufacturing the electrical connector, according to some embodiments;

FIG. 15 is a top perspective view of the electrical connector of FIG. 6, showing 06) of the method of manufacturing the electrical connector, according to some embodiments; and

FIG. 16 is a side view of one second terminal in the first row (A) of terminals and one second terminal in the second row (B) of terminals of the electrical connector of FIG. 6, according to some embodiments.

Reference signs: 1—electrical connector; 10—first terminal; 20—second terminal; 21—less thick portion; 100—terminal assembly; 101—first row of electrically conductive elements; 102—second row of electrically conductive elements, 110—shield; 200—housing; 210—groove; 220—cavity; 230—first rough portion; 240—second rough portion; 250—bracket; 260—terminal assembly housing; 261—first slot; 262—second slot; 263—third slot; 264—accommodating portion; 270—supporting portion; 300—first sealing member; 400—second sealing member; 500—frame; 510—first portion; 520—second portion; 530—third portion.

### DETAILED DESCRIPTION

The inventors have recognized and appreciated techniques for making enhanced electrical connectors, that are enhanced in one or more ways, including that they are simple and cost effective to manufacture, are rugged, withstand environmental conditions and are suitable for use with high power peripheral devices. These techniques may be applied to connectors in a USB-C form factor, in some examples.

Such an electrical connector may have an integrated seal and/or may have both thicker terminals for high power transmission (e.g., 5˜10 A) and thinner terminals for high speed signal transmission (e.g., 5˜80 Gbps). The strength of the connector may be enhanced by having a single, integral component (e.g., a metal frame) to serve as both an outer shell and board holder, which is partially embedded in a connector housing. The connector may be water resistant by having sealing members (e.g., formed by the liquid injection molding (LIM) process) at both the front and rear of the connector. The sealing members may be attached to surfaces of the housing/terminals which were processed to have a higher surface roughness than other portions of the housing/terminals. The sealing members may be formed of liquid silicone. Such a configuration may provide a hybrid connector with reduced height, yet mechanically reliable structure, and achieving the rating of IPX8 immersion testing.

Some aspects of the present disclosure relate to a method of manufacturing an electrical connector. The method may include molding an assembly housing around a bottom row of terminals and a shield, assembling a top row of terminals on the assembly housing, disposing a metal frame in position and then molding a connector housing over. The method may further include roughening selected areas of the housing and the terminals with, for example, laser such that the selected areas may have a surface roughness in the range of VDI24-VDI39, and disposing the front and back LIMs simultaneously. Such a configuration may simplify the manufacturing process and reduces costs.

According to aspects of the present disclosure, a connector may include a housing holding conductive elements in a row. The housing may have a body, a tongue extending from the body in a mating direction, and a bracket extending from a side of the body. Each conductive element may have a mating portion held by the tongue. A frame may be partially embedded in and partially disposed outside the housing to, for example, mount to a board. The frame and bracket may have aligned holes configured for receiving, e.g., a screw to mount to the board. Some conductive elements may be configured for transmitting power and have a uniform thickness; and others may be configured for transmitting signals and have a smaller thickness at the mating portion than a rest of the conductive element. Front and rear seals may be attached to rough surfaces of the housing and conductive elements, respectively. Such techniques may enable a securely sealed hybrid connector capable of reliable mating/mounting within a small space.

According to aspects of the present disclosure, with the terminal assembly provided in the present application, a first terminal configured for transmitting power may have a first thickness, a second terminal configured for transmitting a signal may have a second thickness less than the first thickness. For example, a portion of the second terminal may have the second thickness less than the first thickness of the first terminal. As another example, the second terminal may be thinner compared to conventional signal terminals. Such techniques may enable the connectors for high-speed transmission, alleviating problems with existing USB Type-C terminal structure.

Next, the terminal assembly provided by some embodiments of the present application will be described in detail with reference to the drawings. For a clear and concise description, X, Y, and Z directions may be used in the figure to indicate a horizontal direction X, a mating direction Y, and a vertical direction Z, respectively. The horizontal direction X, the mating direction Y, and the vertical direction Z may be perpendicular to one another. The horizontal direction X may refer to a width direction of an electrical connector of the present application. The mating direction Y may refer to a connecting direction of the electrical connector to another adapted electrical connector, e.g., a mating direction where the electrical connector is mated with a corresponding adapted electrical connector. The vertical direction Z may refer to a height direction (e.g., a thickness direction) of the electrical connector.

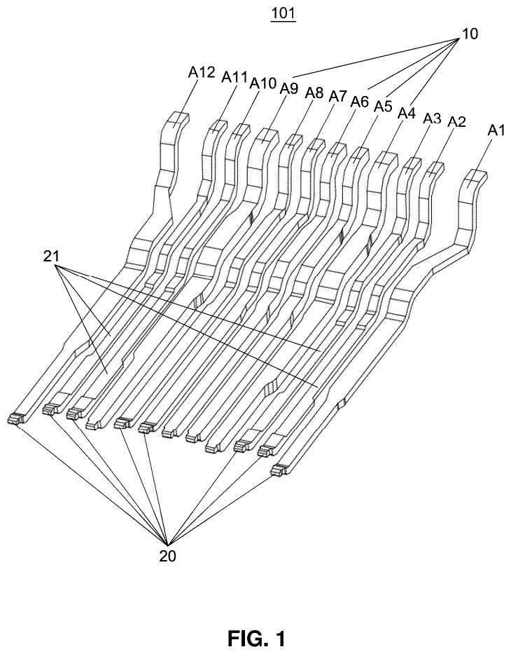

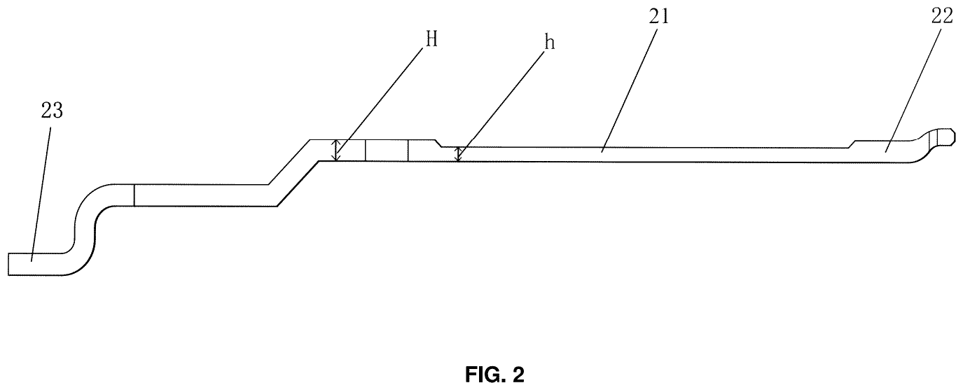

According to some embodiments of the present application, in order to meet the high-speed signal transmission of, for example, the USB Type-C connector, as shown in FIGS. 1 and 2, a terminal assembly 100 of the connector may include a first terminal 10 configured to have a first thickness and transmit power, and a second terminal 20 configured to transmit a signal, at least a portion of each of the second terminals 20 having a second thickness less than the first thickness.

For example, the first terminal 10 serves as a terminal for transmitting power, e.g., a current terminal, and the second terminal 20 serves as a terminal for transmitting a signal, e.g., a signal terminal. The first terminal 10 has a thickness which is a first thickness. The first thickness is in the range of 0.1 mm to 0.35 mm, enabling the first terminal 10 to convey a current in the range of 5 A to 10 A.

The second terminal 20 serves as a terminal for transmitting a signal. In the illustrated exemplary embodiment, after the second terminal 20 is subjected to a thinning process, the second terminal 20 has a thickness at some positions thinner than other positions, with a less thick portion 21 formed. The less thick portion 21 has a thickness which is a second thickness. The second terminals 20 have a thickness in the range of 0.1 mm to 0.25 mm at portions other than the less thick portion; and the less thick portion 21 has a smaller thickness in the range of 0.01 mm to 0.10 mm, enabling the second terminal 20 for high-speed transmission of 5G to 80G per second. For example, the less thick portion has a thickness which is 0.01 mm to 0.10 mm smaller than a thickness of the rest of the second terminal.

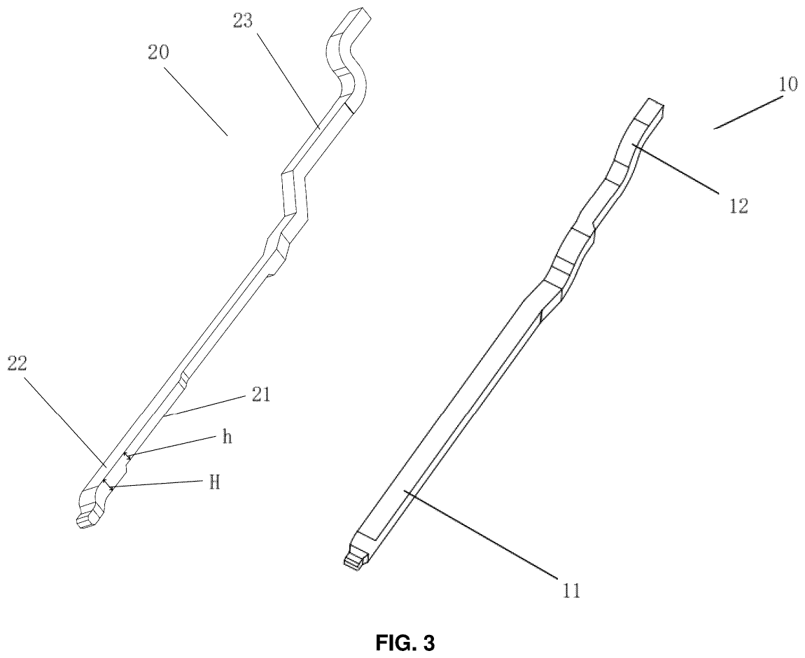

In some embodiments, as shown in FIG. 3, the first terminal 10 may comprise a mating portion 11 and a tail portion 12. The second terminal 20 may comprise a mating portion 22 and a tail portion 23. The mating portion 22 of the second terminal 20 comprises the less thick portion 21, and the less thick portion 21 has a thickness h less than a thickness H of other sections of the mating portion 22 of the second terminal 20. The mating portion 11 of the first terminal has a uniform thickness in a length direction thereof.

Each of the first terminal and the second terminal has a thickness which is a thickness of each of the first terminal and the second terminal in a vertical direction, e.g., a height direction Z of the electrical connector.

In some examples, the less thick portion 21 of the second terminal 20 is formed by a stamping process, such as a stamping molding process. It should be appreciated that stamping process is a production technology that, by stamping equipment (presses) and tools (dies), exerts pressure on panel metal or non-metal to have separation or plastic deformation, thus obtaining a product with a certain shape, size and performance requirements.

It should be appreciated that the expression “mating” as used in the description of the present application may refer to an end of the connector facing the mating connector when the connector is connected to the corresponding mating connector, whereas the expression “tail” may refer to an end of the connector facing away from the mating connector when the connector is connected to the corresponding mating connector. For example, “mating” and “tail” may indicate opposite ends of the connector in the mating direction, respectively.

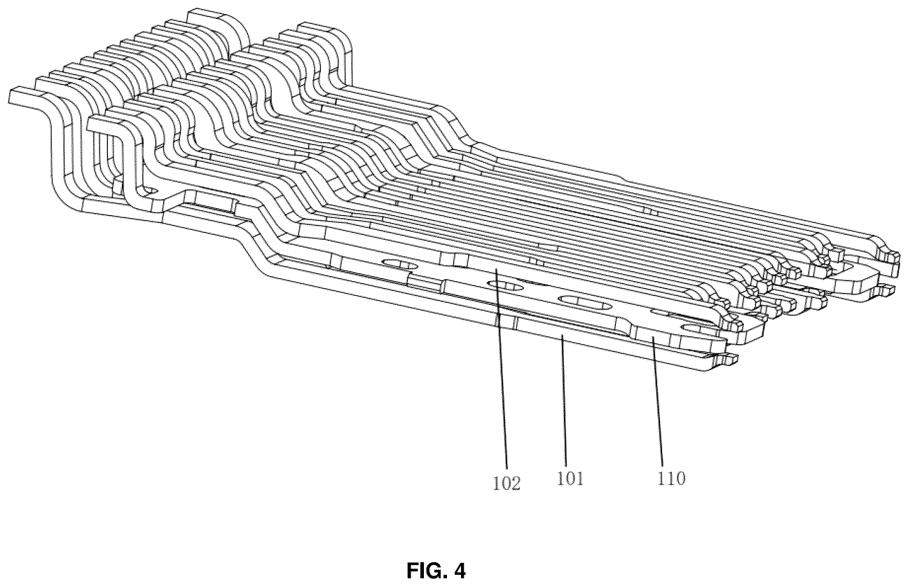

In some embodiments, as shown in FIG. 4, the terminal assembly 100 includes a plurality of first terminals 10 and a plurality of second terminals 20 provided in a row. In the illustrated exemplary embodiment, the terminal assembly 100 includes two rows of terminals, each row including a plurality of first terminals 10 and a plurality of second terminals 20. As shown in FIG. 4, a first row of terminals of the two rows of terminals may include both first terminals 10 and second terminals 20. A second row of terminals of the two rows of terminals may also include both first terminals 10 and second terminals 20. In some embodiments, corresponding first terminals 10 and second terminals 20 forming either of the two rows of terminals may be arranged in an array.

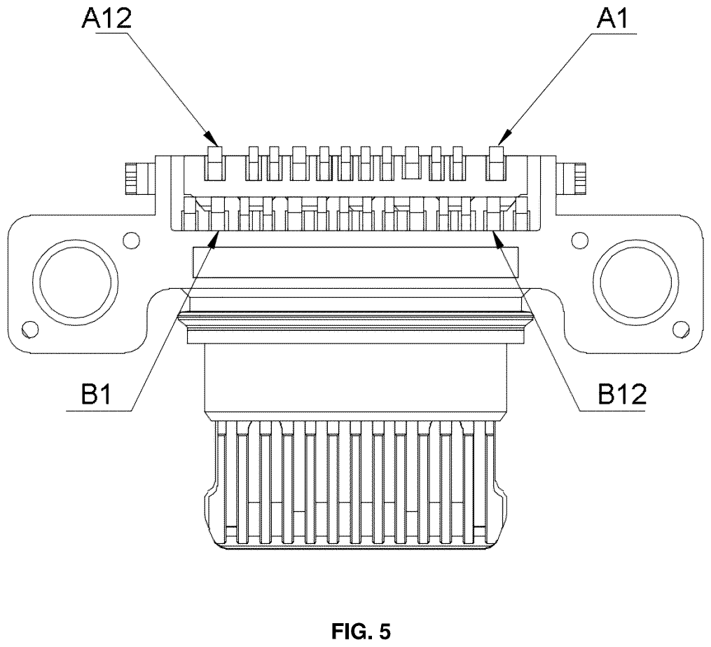

According to an exemplary embodiment of the present application, as shown in FIG. 5, the terminal assembly is provided with a total of two rows of terminals, e.g., a row A of terminals and a row B of terminals spaced apart in a thickness direction of the terminal assembly in FIG. 5, where a row of terminals located at an upper position of FIG. 5 is indicated from right to left as A1, A2, A3, A4, A5, A6, A7, A8, A9, A10, A11 and A12, and a row of terminals located at a lower position of FIG. 5 is indicated from left to right as B1, B2, B3, B4, B5, B6, B7, B8, B9, B10, B11 and B12.

In the illustrated exemplary embodiment, each of the row A of terminals and the row B of terminals includes a first terminal 10 and a second terminal 20, with the first terminal 10 and the second terminal 20 being provided side-by-side to form a row of terminals. The terminals of A4, A5, A6, A9 and B4, B5, B6, B9 as the first terminal 10 have a thickness from 0.1 mm to 0.35 mm to provide a rated current 5 A to 10 A. The terminals of A1, A2, A3, A7, A8, A10, A11 and A12 and the B1, B2, B3, B7, B8, B10, B11, B12 as the second terminal 20 have a thickness from 0.1 mm to 0.25 mm to provide the high-speed signal transmission from 5G to 80G.

As shown in FIG. 2, in some embodiments, the second terminal 20 may be first formed with a terminal material thickness in the range of 0.10 mm to 0.25 mm. In order to better meet the high-frequency structural requirements, the second terminal 20 may be subjected to a thinning process with a thinning depth of 0.01 mm to 0.10 mm. In an optional exemplary embodiment, four of the second terminals 20 may be subjected to a thinning process. Referring to FIG. 1, A2, A3, A10, and A11 of the terminals in row A as the second terminal 20 are subjected to a thinning process.

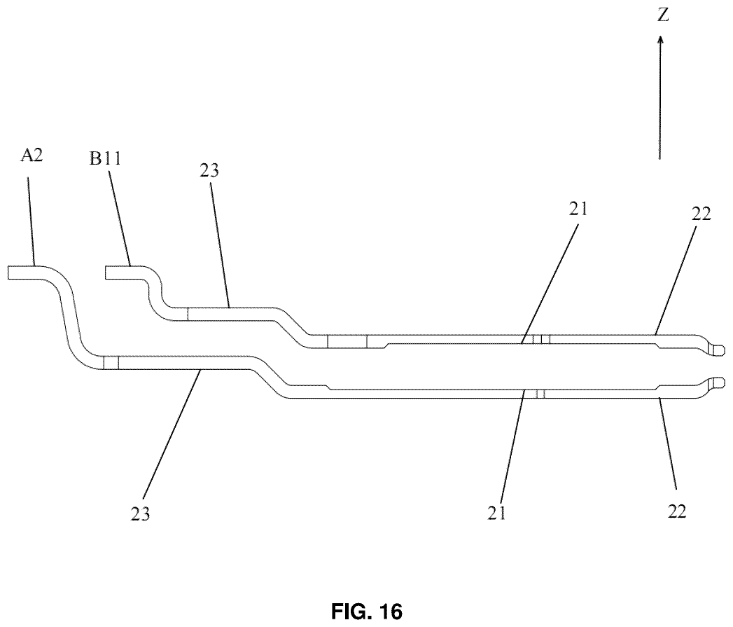

In the illustrated exemplary embodiment, the terminals in row A and the terminals in row B are aligned with each other in the vertical direction Z (a height direction of the terminal assembly). In the optional exemplary embodiment, the second terminals 20 subjected to a thinning process of the terminals in row A are aligned with the second terminals 20 subjected to a thinning process of the terminals in row B in the vertical direction Z. In the illustrated exemplary embodiment, corresponding to subjecting the A2, A3, A10 and A11 as the second terminals 20 in the row A of terminals to a thinning process, B2, B3, B10, B11 as the second terminals 20 in the B row of terminals are subjected to a thinning process and the terminals A2, A3, A10 and A11 are aligned in the vertical direction Z with B11, B10, B3 and B2 one to another respectively. In some embodiments, a concave portion formed by subjecting the second terminal in the row A of terminals to a thinning process and a concave portion formed by subjecting the second terminal in the row B of terminals to a thinning process are provided in the vertical direction Z facing each other. Referring to FIG. 16, as an example, a concave portion formed by subjecting the terminal A2 in the row A of terminals to a thinning process is provided to face the row B of terminals in the vertical direction Z, and a concave portion formed by subjecting the terminal B11 in the row B of terminals to a thinning process is provided to face the row A of terminals in the vertical direction Z.

Optionally, the first terminal 10 and the second terminal 20 are provided with a corrosion-resistant plating layer, the material of the plating layer being any one of platinum, rhodium-ruthenium, and palladium. For example, terminal surfaces of the first terminal 10 and the second terminal 20 are treated with special plating layers such as a platinum plating layer, a rhodium-ruthenium plating layer, or a palladium plating layer to meet the corrosion resistance effect.

In some embodiments, surfaces of the first terminal 10 and the second terminal 20 are treated with platinum, rhodium-ruthenium, and palladium by electroplating plating to form a corresponding plating layer, thereby forming a uniform, dense, and well-bonded metal surface while improving the corrosion resistance of the corresponding terminals.

With the terminal assembly 100 provided by the exemplary embodiment of the present application, a first terminal 10 for transmitting power has a thickness as a first thickness, a second terminal 20 for transmitting a signal has a thickness as a second thickness less than the first thickness, For example, a portion of the second terminal 20 has a thickness less than a thickness of the first terminal 10, and the second terminal 20 is thinner compared to the traditional signal terminal, and is able to meet the demand for high-speed transmission, alleviating the technical problem existing in the prior art that the USB Type-C terminal structure is unable to meet the high-speed signal transmission.

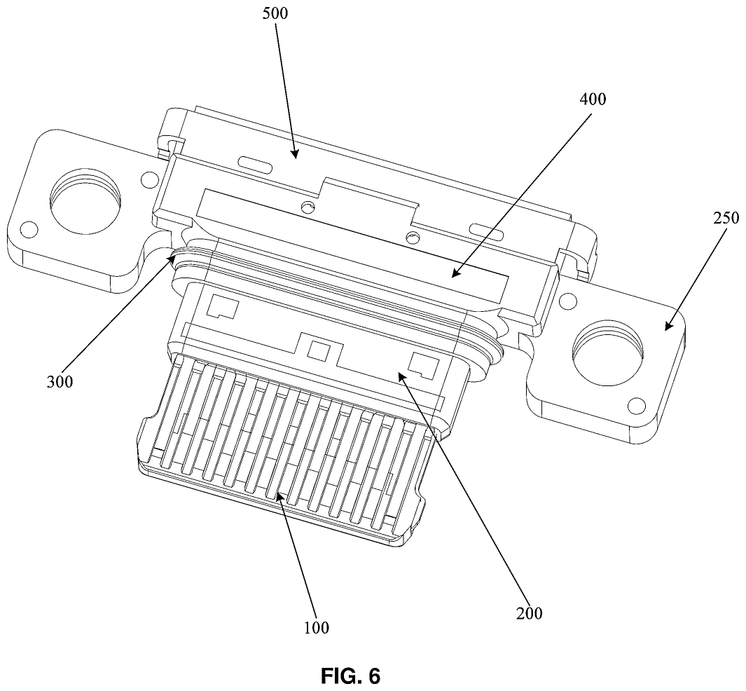

As shown in FIGS. 5 and 6, an electrical connector 1 is provided according to another aspect of embodiments of the present application, and the electrical connector 1 may be applicable to 5G cell phones, tablet PCs, adapters, communication devices, network devices, routing, and notebook PCs, e-cigarettes, and the like. As an example, the electrical connector 1 may be a USB Type-C connector.

In the illustrated exemplary embodiment, the electrical connector 1 according to the present application may include a housing and a terminal assembly. The terminal assembly may be a terminal assembly 100 as described above in the preceding embodiment. As described in the preceding embodiment, in the terminal assembly 100, the first terminal 10 and the second terminal 20 are both provided in a plurality and form two rows of terminals arranged above each other. In the illustrated exemplary embodiment, the housing 200 of the electrical connector 1 is sleeved outside the two rows of terminals for fixing the two rows of terminals.

For example, the electrical connector 1 includes a terminal assembly 100 and a housing 200, the housing 200 is sleeved onto at least a portion of an outside portion of the terminal assembly 100; the terminal assembly 100 includes a plurality of first terminals 10 and a plurality of second terminals 20, the first terminals 10 and the second terminals 20 are formed to have an elongated strip shape. Some of the first terminals 10 and the second terminals 20 are arranged to form a row of terminal groups, e.g., a first row of electrically conductive elements 101, and the others of the first terminals 10 and the second terminals 20 are arranged to form another row of terminal groups, e.g., a second row of electrically conductive elements 102, as shown in FIG. 4.

According to an exemplary embodiment of the present application, one row of terminals of the two rows of terminals is configured as a first row of electrically conductive elements 101 formed by some of the plurality of first terminals 10 and some of the plurality of second terminals 20, and the other row of terminals of the two rows of terminals is configured as a second row of electrically conductive elements 102 formed by the others of the plurality of first terminals 10 and the others of the plurality of the second terminals 20.

In the illustrated exemplary embodiment, the first row of electrically conductive elements 101 and the second row of electrically conductive elements 102 are spaced apart from each other in a thickness direction Z of the electrical connector 1, and a plastic member as housing 200 is molded outside the first row of electrically conductive elements 101 and the second row of electrically conductive elements 102.

In some embodiments, the first row of electrically conductive elements 101 and the second row of electrically conductive elements 102 are arranged opposite to each other. In some embodiments, the first terminal 10 may comprise a mating portion 11 and a tail portion 12. The second terminal 20 may comprise a mating portion 22 and a tail portion 23.

In some embodiments, the terminal assembly 100 includes an insulative terminal assembly housing and a plurality of first terminals 10 and a plurality of second terminals 20 integrally molded with the insulative terminal assembly housing. Some of the first terminals 10 and some of the second terminals 20 are provided in rows in the horizontal direction X to form a first row of electrically conductive elements 101, and the others of the first terminals 10 and the others of the second terminals 20 are provided in rows in the horizontal direction X to form a second row of electrically conductive elements 102. The first row of electrically conductive elements 101 and the second row of electrically conductive elements 102 are arranged opposite to each other in the thickness direction Z of the electrical connector 1, such that at least a portion of the second terminals 20 forming the first row of electrically conductive elements 101 and at least a portion of the second terminals 20 forming the second row of electrically conductive elements 102 have less thick portions subjected to a thinning process, and the second terminals 20 forming the first row of electrically conductive elements 101 and having the less thick portion and the second terminals 20 forming the second row of electrically conductive elements 102 and having the less thick portion are aligned up and down with each other along the height direction Z.

In some embodiments, as shown in FIG. 4, the terminal assembly 100 further comprises a shield 110 provided between the first row of electrically conductive elements 101 and the second row of electrically conductive elements 102 in the thickness direction Z of the electrical connector 1. The shield 110 is spaced apart from the first row of electrically conductive elements 101 and the second row of electrically conductive elements 102, respectively, by a predetermined distance in the height direction Z of the electrical connector 1. The shield 110 is configured to shield a signal interference between two rows of electrically conductive terminals.

In some embodiments, the housing 200 comprises an terminal assembly housing 260, and the terminal assembly housing 260 may be defined with a portion for accommodating the first terminal 10 and the second terminal 20. Each of the mating portion 11 of the first terminal 10 and the mating portion 22 of the second terminal 20 of the terminal assembly 100 is molded into the housing portion of the terminal assembly housing 260 by injection molding.

In some embodiments, the shield 110 may be molded into the housing portion of the terminal assembly housing by injection molding together with the tail portions 12 of the first terminals 10 and/or the tail portions 23 of the second terminals 20, to form an integrally molded member.

In some embodiments, the shield 110 may be formed as a plate. Optionally, the shield 110 formed as a plate may be provided between the first row of electrically conductive elements 101 and the second row of electrically conductive elements 102, and parallel to the first row of electrically conductive elements 101 and the second row of electrically conductive elements 102 respectively.

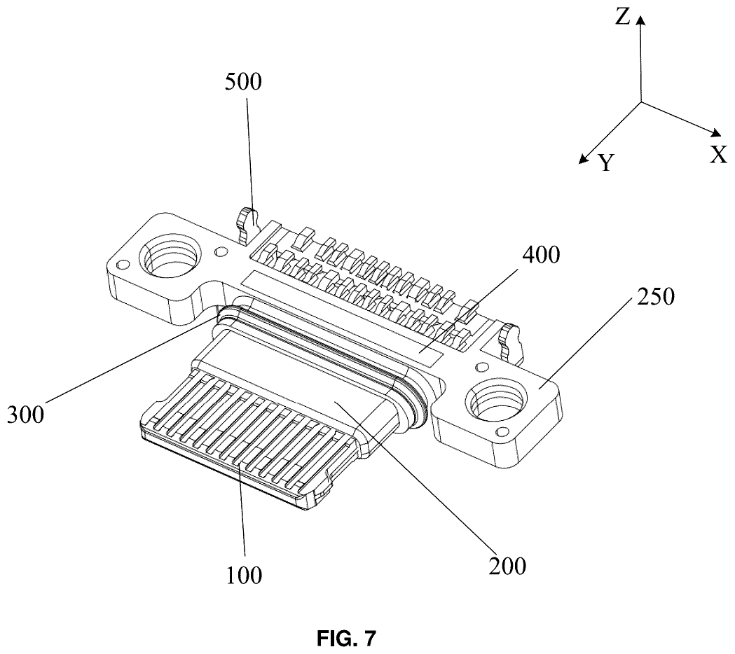

Referring to FIGS. 6 to 8, the electrical connector 1 comprises a first sealing member 300. A groove 210 is provided along a circumferential direction of the housing 200 and the first scaling member 300 is provided inside the groove 210.

For example, a groove 210 is disposed along a circumferential portion of the housing 200. The first sealing member 300 is formed in the groove 210 by the LIM process (liquid injection molding), and the first sealing member 300 fills the groove 210 to achieve the effect of front sealing of the electrical connector 1.

In exemplary embodiments according to the present application, the groove 210 is provided in a region of the housing 200 close to tail portions of the terminals forming the first row of electrically conductive elements 101 and the second row of electrically conductive elements 102.

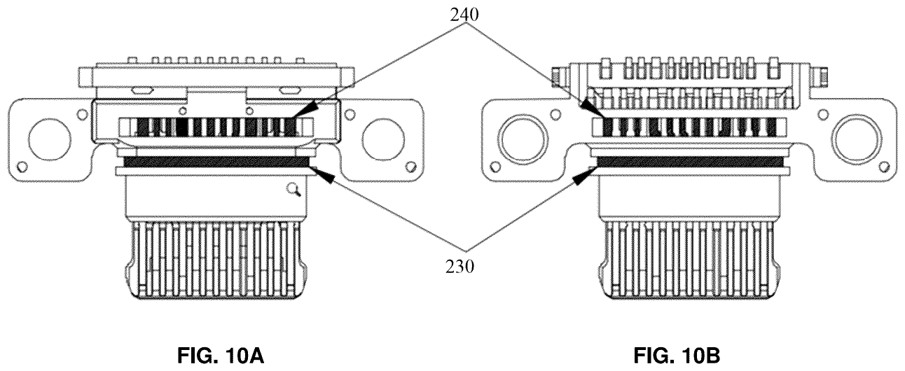

In some embodiments, the groove 210 is roughened to form a rough portion by roughening a groove bottom of the groove 210 by laser engraving processing (also known as laser processing) or electrical discharge processing (referring to FIGS. 10A-B). The so-called “groove bottom” of the groove 210 comprises surfaces of a bottom wall and two side walls connected to the bottom wall that constitute the groove. For example, the groove surface of the groove 210 may be embossed or knurled to form a rough portion.

In some embodiments, the first sealing member 300 may be formed as follows: placing a rough portion of the groove 210 to be processed in the adhesive forming tool using an adhesive forming tool that matches with the first sealing member 300 in terms of a predetermined size and shape, applying an adhesive at the rough portion in a circumferential direction of the housing 200. In some examples, the adhesive is applied in the adhesive forming tool by one of the following: time and pressure type dispensing, piston pump dispensing, and screw metering pump dispensing.

Optionally, the adhesive forming tool accommodates an adhesive, which may be selected from one of the following: UV adhesive, silicone, epoxy resin adhesive.

In exemplary embodiments according to the present application, the electrical connector 1 further comprises a second sealing member 400; and the housing 200 is provided with a cavity 220 having a hole depth direction perpendicular to a top surface of the terminal assembly 100, and the second sealing member 400 is provided within the cavity 220.

For example, the cavities 220 are provided throughout the housing 200, For example, the cavities 220 are provided on both sides of the housing 200, and two cavities 220 are provided opposite to each other, and the terminal assembly 100 is located between the two cavities 220, and a second sealing member 400 is formed in the cavities 220 by the LIM process, and the cavities 220 are sealed off by the second sealing member 400, implementing the rear sealing effect of the electrical connector.

Referring to FIGS. 6 to 8, in some embodiments of the present application, the housing 200 may include a supporting portion 270 formed in the vicinity of a tail end of the housing 200. The supporting portion 270 may be configured as a stop portion for stopping excessive movement of the electrical connector 1 in the mating direction Y when the electrical connector 1 is mated with an adapted corresponding electrical connector.

In the illustrated exemplary embodiment, the cavities 220 are provided on two opposite surfaces of the supporting portion 270 in the thickness direction Z of the electrical connector 1. In the case where the second sealing member 400 is not provided, a portion of the tail portion of the terminals forming the first row of electrically conductive elements 101 and the second row of electrically conductive elements 102 may be visible from the outside of the electrical connector 1 via the cavities 200.

In the illustrated exemplary embodiment, the groove 210 is provided at a predetermined distance from the supporting portion 270 and is located at a mating side of the supporting portion 270, so that when the electrical connector 1 is mated with the adapted corresponding electrical connector in the mating direction Y, the first sealing member 300 provided in the groove 210 is first brought into contact with an engagement portion of the adapted corresponding electrical connector to realize a front sealing effect of the electrical connector 1.

For example, an inner surface of the cavity 220 may be roughened, as in the case of the groove 210, either by laser engraving processing (also known as laser processing) or electrical discharge processing to form a rough portion; or an outer surface of the groove 210 are embossed or knurled to form a rough portion.

In some embodiments, the second sealing member 400 is formed as follows: placing a rough portion of the groove 220 to be processed in the adhesive forming tool by using an adhesive forming tool that matches with the second sealing member 400 in terms of a predetermined size and shape, and applying an adhesive at the rough portion in a circumferential inner surface of the cavity 220.

In some embodiments, the rough portion comprises a pattern formed by at least one of a diagonal pattern, a grid pattern, or a predetermined symbol pattern. For example, the predetermined symbol pattern comprises at least one of a Union Jack shape, a H shape, or a X shape.

In some embodiments, the first sealing member 300 is configured to have an annular shape extending continuously in a circumferential direction around an outer peripheral surface of the housing 200 close to the supporting portion 270. Optionally, the sealing member 300 is configured to have an attachment surface forming a positive fit with the groove.

In some embodiments, the cavity 220 may be configured to have a square open cross-sectional shape, and thus the second sealing member 400 is configured to have a substantially square shape and to have an attachment surface forming a positive fit with the cavity 220.

It should be appreciated that the term “a positive fit” used in the present application may refer to a relationship in which two mating components are abutting and tightly fit with each other in terms of the shape and the position.

In some embodiments, the first sealing member 300 and/or the second sealing member 400 may be elastically deformable members. The first sealing member 300 and the second sealing member 400 are configured to elastically deform when the first sealing member 300 and the second sealing member 400 contact with the mounting portions of the adapted corresponding electronic device (for example, a portion of the shell of the adapted connector of the electronic device) and to form an interference fit with the mounting portions of the electronic device in a direction perpendicular to the mating direction Y. In one example, the sealing member may be made of ultraviolet light-curable adhesive (UV adhesive), silicone, or epoxy resin adhesive. Ultraviolet light-curable adhesive is rapidly cured into an elastic adhesive film under UV light irradiation, and is characterized by high adhesive strength, vibration resistance, high temperature resistance, and good durability, etc.

With the electrical connector 1 according to the exemplary embodiment of the present application, in particular, in the embodiment where the grooves 210 and/or the cavities 220 are formed with a rough portion, since the rough portion increases the surface roughness of the contact surfaces between the sealing members 300, 400 and the corresponding grooves 210, cavities 220 of the housing 200, the adhesion force of the sealing members on the housing is improved, and the sealing performance of the electrical connector 1 is ensured.

With the above technical solution, a very close attachment between the first sealing member and/or the second sealing member and the housing can be provided, and the outer sidewall of the housing of the connector provided with the rough portion has a surface roughness higher than a surface roughness of other portions of the housing, thereby significantly improving an adhesion force between the first sealing member and/or the second sealing member and the rough portion of the main housing, reducing the risk of the sealing member falling off. Therefore, a seamless seal can be generated between the connector and the mounting portion of the electronic device when mounting the connector to the mounting portion of the electronic device to reduce the risk of water vapor/dust entering inside the electronic device.

Optionally, as shown in FIG. 6, in order to increase the adhesion force of the first scaling member 300 and the second sealing member 400 on the housing 200, the housing 200 is provided with a first rough portion 230 at a groove bottom of the groove 210, and the terminal assembly 100 is provided with a second rough portion 240 in a region where the cavity 220 is projected on the terminal assembly 100 in a hole depth direction, where the first rough portion 230 and the second rough portion 240 are forming by a laser process to increase the surface roughness, so as to increase the adhesion force of the first sealing member 300 and the second sealing member 400 to meet the waterproof requirement.

In some embodiments, the seal may comprise a front sealing member and a rear scaling member. The adhesion force of LIM may be increased by roughening attachment surfaces with such as laser. Such a configuration may enable the connector to satisfy IPX8 immersion testing.

In some embodiments according to the present application, as shown in FIGS. 6 to 8, the electrical connector I may further include a frame 500. The frame 500 may be configured to increase the strength of the housing 200. The frame 500 has a first portion 510 embedded in the supporting portion 270 of the housing 200, a second portion 520 disposed outside of the housing 200, and a third portion 530 formed by extending from both sides of the first portion 510. In the width direction X of the electrical connector 1, a bracket 250 is formed by extending form both sides of the supporting portion 270 of the housing 200. The bracket 250 may have threaded holes. The third frame portion 530 of the frame 500 is embedded in the bracket 250.

It should be noted that the first portion 510, the second portion 520, and the third portion 530 are connected with each other. For example, the first portion 510, the second portion 520, and the third portion 530 may be formed integrally such as stamped from a single sheet. For example, the first portion 510 is embedded in the housing 200 using insert molding, the third portion 530 is embedded in the bracket 250 using insert molding, and the second portion 520 is disposed on the housing 200, enhancing the strength of the product, improving resistant to falling, and simplifying the manufacture of the product.

With the electrical connector 1 provided according to the exemplary embodiment of the present application, the first sealing member 300 and the second sealing member 400 are molded integrally by using LIM to meet the waterproof requirements of the electrical connector, leading a simpler process; moreover, the laser process is used to form the first rough portion 230 and the second rough portion 240, to increase the surface roughness and to increase the adhesion force of the sealing members to meet the waterproofing requirements; the first portion and the third portion of the frame 500 are embedded into the housing 200 to improve the strength of the housing 200.

Embodiments according to yet another aspect of the present application provide a method for manufacturing an electrical connector 1.

According to an exemplary embodiment of the present application, the method for manufacturing an electrical connector 1 may comprise: Step 01) providing a plurality of first terminals 10 and a plurality of second terminals 20, and forming a first row of electrically conductive elements 101 (lower row of terminals) and a second row of electrically conductive elements 102 (upper row of terminals respectively by the plurality of first terminals 10 and the plurality of second terminals 20.

In some embodiments, in Step 01), the plurality of first terminals 10 and the plurality of second terminals 20 are arranged in rows such that each row includes the first terminals 10 and the second terminals 20 arranged in an array.

In some embodiments, referring to FIGS. 1 and 4, Step 01) may include forming a first row of electrically conductive elements 101 by arranging some of the plurality of first terminals 10 and some of the plurality of second terminals 20 in an array, and forming a second row of electrically conductive elements 102 by arranging the others of the plurality of first terminals 10 and the others of the plurality of second terminals 20 in an array.

The method may comprise Step 02) providing a shield (110).

In some embodiments, Step 02) may include providing the shield 110 formed as a plate.

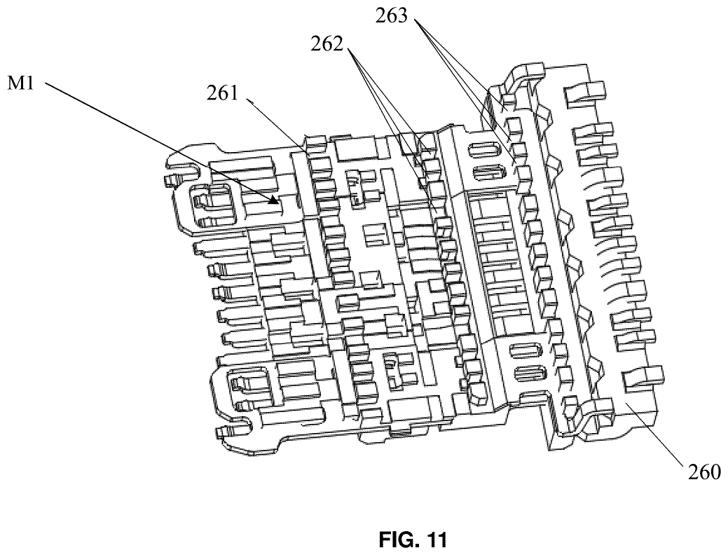

The method may comprise Step 03) placing the first row of electrically conductive elements 101 (lower row of terminals) and the shield 110 (intermediate shielding plate) in a first injection mold and forming a first injection molding to form a first molding member M1, where the first row of electrically conductive elements 101 and the shield 110 are spaced apart from each other in the thickness direction Z of the electrical connector 1, as shown in FIG. 11.

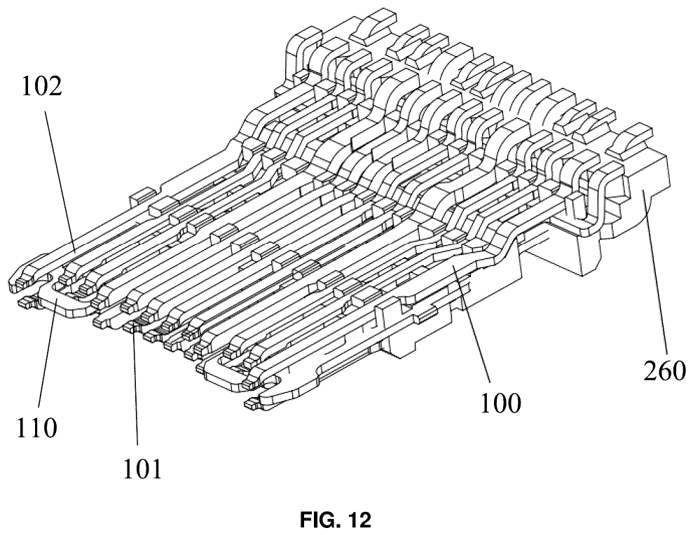

Referring to FIGS. 11 and 12, in some embodiments, in Step 03), a mounting slot for assembling the second row of electrically conductive elements 102 may be integrally molded on a side of the first molding member M1 opposite to a side of the shield 110 positioning the first row of electrically conductive elements 101. FIG. 11 shows a state of the first molding member M1 with the second row of electrically conductive elements 102 unassembled. FIG. 12 shows a state of the first molding member M1 after assembling the second row of electrically conductive elements 102 to the first molding member M1.

In the illustrated exemplary embodiment, the first molding member M1 includes a terminal assembly housing 260 formed by injection molding around the first row of electrically conductive elements 101 (lower row of terminals) and the shield 110 (intermediate shielding plate). The terminal assembly housing 260 is configured with a mounting slot for assembling the second row of electrically conductive elements 102, on a side of the first molding member M1 opposite to a side of the shield 110 positioning the first row of electrically conductive elements 101.

In some embodiments, as shown in FIG. 11, the mounting slot may comprise a plurality of first slots 261 close to a mating end side of the terminal assembly 100 (/the first molding member M1), a plurality of third slots 263 close to a tail end side of the terminal assembly 100 (/the first molding member M1), and a plurality of second slots 262 provided between the plurality of first slots 261 and the plurality of third slots 263 along a mating direction Y of the electrical connector 1. The first slots 261, the second slots 262 and the third slots 263 may have the same number, and the corresponding first slots 261, second slots 262 and third slots 263 aligned with one another in the mating direction Y of the electrical connector 1 are used for housing and positioning one of the terminals forming the second row of electrically conductive elements 102.

The method may comprise Step 04) assembling the second row of electrically conductive elements 102 onto the first molding member M1, and positioning the second row of electrically conductive elements 102 (upper row of terminals) relative to the first molding member M1 in a manner that the second row of electrically conductive elements is spaced from the first row of electrically conductive elements 101 from each other in the height direction Z of the electrical connector 1 and that the shield 110 is located between the first row of electrically conductive elements 101 and the second row of electrically conductive elements 102, as shown in FIG. 12.

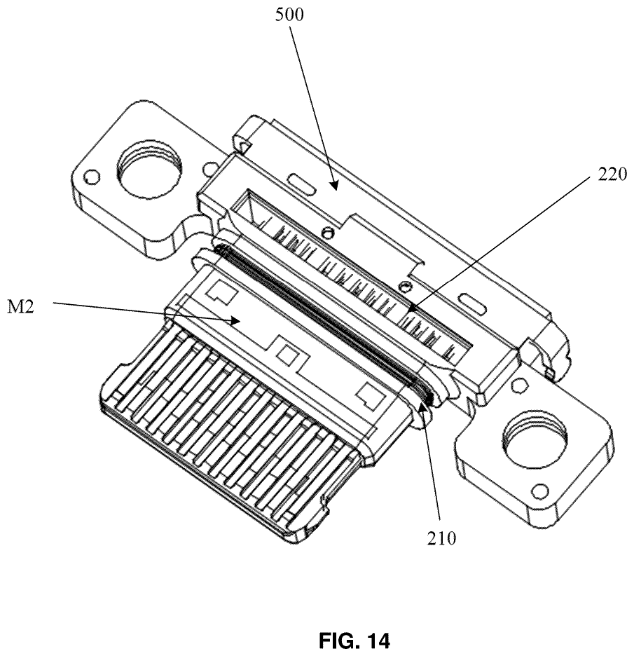

The method may comprise Step 05) placing the first row of electrically conductive elements (upper row of terminals) and the first molding member M1 into a second injection mold, and providing a frame 500 as a reinforcing member, and positioning the frame 500 in a predetermined position relative to the first molding member M1 and the second row of electrically conductive elements 102 assembled together in Step 04), and subsequently performing a second injection molding (over-injection molding) with the assembled reinforcing member (the frame 500), the second row of electrically conductive elements 102, and the first molding member M1 as the mold core to form a second molding member M2, as shown in FIG. 14.

According to exemplary embodiments of the present application, a second molding member M2 is formed by over-injection molding the first molding member M1, the second row of electrically conductive elements 102, and the frame 500 assembled together, and the frame 500. The second molding member M2 comprises a housing 200. By two-step-injection molding, the frame 500 is embedded into the interior of the housing 200, thereby providing a greater rigidity to the electrical connector.

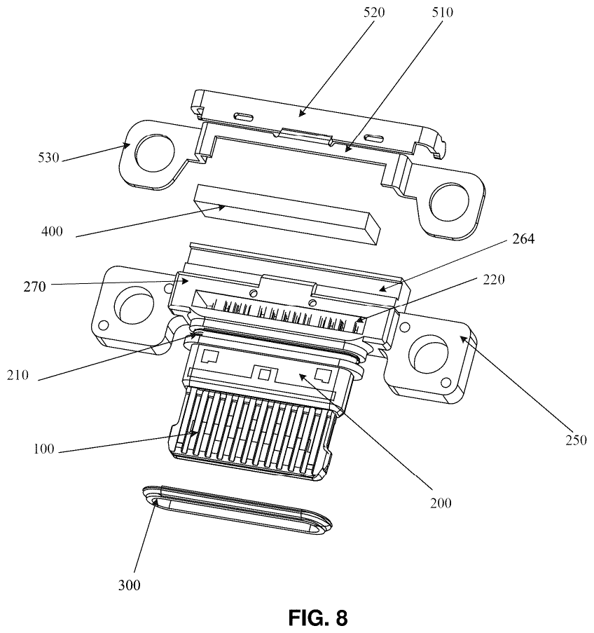

In the illustrated exemplary embodiment, as shown in FIG. 8, the frame 500 as a reinforcing member may be configured with a first portion 510 as a central portion of the frame 500; a second portion 520 extending from the first portion 510 in the mating direction Y of the electrical connector 1 toward a tail end of the electrical connector 1; and a third portion 530 overhanging from both side of the first portion 510 in a width direction X of the electrical connector 1 along a thickness direction Z of the electrical connector I toward a side of the second row of electrically conductive elements 102, the third portion 530 being formed with an L-shaped stepped portion having legs parallel to the first portion 510.

In some embodiments, in Step 03), an accommodating portion 264 (referring to FIG. 8) for accommodating the second portion 520 of the frame 500 may be provided on a side of the terminal assembly housing 260 on which the first row of electrically conductive elements 101 is provided and close to the tail end of the first molding member M1 during forming the first molded member M1, for positioning the frame 500 in a predetermined position relative to the first molding member M1 and the second row of electrically conductive elements 102 assembled together in Step 04).

In some embodiments, during performing a secondary injection molding (over-injection molding) to form the second molding member M2, the first portion 510 of the frame 500 may be embedded in the housing 200 formed by the second molding member M2 by molding, and the second portion 520 is exposed outside of the housing 200. The third portion 530 of the frame 500 may be embedded in the housing 200 formed by the second molding member M2 by molding, to form the bracket 250 of the electrical connector 1.

In some embodiments, during performing a secondary injection molding (over-injection molding) to form the second molding member M2, a supporting portion 270 may be formed by molding close to the tail end of the housing 200. The first portion 510 of the frame 500 is embedded in the supporting portion 270 of the housing 200.

In some embodiments, during performing a secondary injection molding (over-injection molding) to form the second molding member M2, a groove 210 may be formed at a predetermined distance from the supporting portion 270 of the housing 200 and at the mating end side of the supporting portion 270, as shown in FIG. 14.

In some embodiments, during performing a secondary injection molding (over-injection molding) to form the second molding member M2, cavities 220 may be formed on two opposite surfaces of the supporting portion 270 of the housing 200 in the thickness direction Z of the electrical connector 1, as shown in FIG. 14.

Optionally, groove surfaces of the groove 210 and inner surfaces of the cavities 220 may be roughened to form roughened portions by a laser engraving process (also referred to as a laser process), or an electrical discharge process, or an embossing or knurling process. In an exemplary embodiment, a first rough portion 230 may be formed on a groove surface of the groove 210, as shown in FIGS. 10A-B. A second rough portion 240 may be provided in a region where the cavity 220 is projected on the terminal assembly 100 in a hole depth direction.

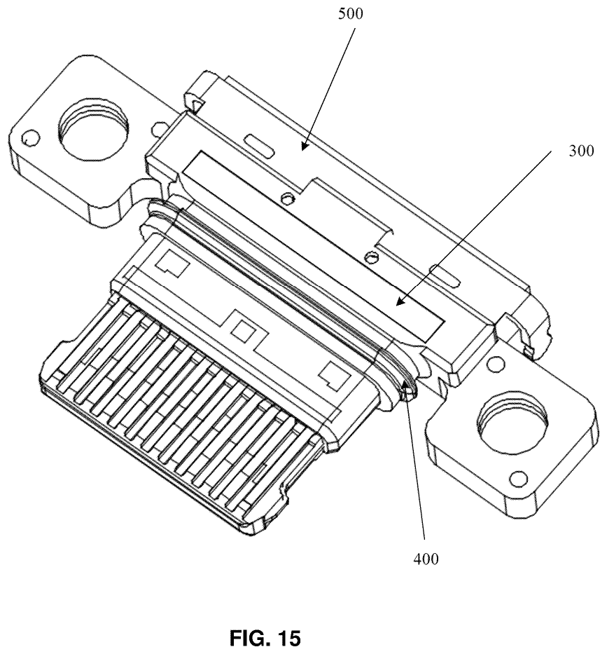

The method may comprise 06) applying an adhesive to the first rough portion 230 and the second rough portion 240, respectively, and the adhesive is cured to form the first scaling member 300 and the second sealing member 400 at the first rough portion 230 and the second rough portion 240, respectively, as shown in FIGS. 10 and 15.

It should be appreciated that the method of manufacturing the electrical connector of the present application is not limited to the method described in the above specific embodiment, and that the individual acts described involve only a non-exhaustive list and do not have a specific order, and the order of the acts can be adjusted by those skilled in the art as actually needed.

Various aspects are described in this disclosure, which include, but are not limited to, the following aspects:

1. A terminal assembly (e.g., 100) wherein the terminal assembly comprises: a first terminal (e.g., 10) configured to have a first thickness and transmit power, and a second terminal (e.g., 20) configured to transmit a signal, at least a portion of each second terminal (e.g., 20) is configured to have a second thickness less than the first thickness.

2. The terminal assembly according to aspect 1 or any other aspect, wherein the first thickness is in the range of 0.1 mm to 0.35 mm.

3. The terminal assembly according to aspect 1 or any other aspect, wherein the second terminal (e.g., 20) is configured to have a less thick portion (e.g., 21) subjected to a thinning process, and the less thick portion (e.g., 21) is configured to have a thickness as the second thickness; the second terminal (e.g., 20) is configured have a thickness in the range of 0.1 mm to 0.25 mm at portions other than the less thick portion (e.g., 21); and the less thick portion (e.g., 21) is configured to have a smaller thickness in the range of 0.01 mm to 0.10 mm.

4. The terminal assembly according to aspect 3 or any other aspect, wherein the first terminal (e.g., 10) comprises a mating portion (e.g., 11) and a tail portion (e.g., 12), the second terminal (e.g., 20) comprises a mating portion (e.g., 22) and a tail portion (e.g., 23), the mating portion (e.g., 22) of the second terminal (e.g., 20) comprises the less thick portion (e.g., 21), and the mating portion (e.g., 11) of the first terminal (e.g., 10) is configured to have a uniform thickness.

5. The terminal assembly according to aspect 1 or any other aspect, wherein the first terminal (e.g., 10) is configured to be able to convey a current in the range of 5 A to 10 A; and the second terminal (e.g., 20) is configured to be able to transmit signals at a speed in the range of 5 Gbps to 80 Gbps per second.

6. The terminal assembly according to aspect 1 or any other aspect, wherein each of the first terminal (e.g., 10) and the second terminal (e.g., 20) is provided with a corrosion-resistant plating layer, a material of the plating layer is any one of platinum, rhodium-ruthenium, and palladium.

7. An electrical connector, wherein the electrical connector comprises a housing (e.g., 200) and a terminal assembly (e.g., 100) according to any one of aspects 1 to 6 or any other aspect; wherein a plurality of the first terminal (e.g., 10) and a plurality of the second terminal (e.g., 20) are provided and form two rows of terminals arranged above each other in a height direction (Z) of the electrical connector; and the housing (e.g., 200) is sleeved outside the two rows of terminals for fixing the two rows of terminals.

8. The electrical connector according to aspect 7 or any other aspect, wherein one row of terminals of the two rows of terminals is configured as a first row of electrically conductive elements (e.g., 101) formed by some of the plurality of first terminals (e.g., 10) and some of the plurality of second terminals (e.g., 20), and the other row of terminals of the two rows of terminals is configured as a second row of electrically conductive elements (e.g., 102) formed by the others of the plurality of first terminals (e.g., 10) and the others of the plurality of the second terminals (e.g., 20), the first row of electrically conductive elements (e.g., 101) and the second row of electrically conductive elements (e.g., 102) are disposed opposite to each other in the height direction of the electrical connector.

9. The electrical connector according to aspect 8 or any other aspect, wherein at least some of the plurality of second terminals forming the first row of electrically conductive elements (e.g., 101) and at least some of the plurality of second terminals forming the second row of electrically conductive elements (e.g., 102) are configured to have less thick portions subjected to a thinning process, and the second terminals forming the first row of electrically conductive elements (e.g., 101) and having the less thick portion and the second terminals forming the second row of electrically conductive elements (e.g., 102) and having the less thick portion are aligned with each other in the height direction.

10. The electrical connector according to aspect 8 or 9 or any other aspect, wherein the terminal assembly (e.g., 100) comprises a shield (e.g., 110) located between the first row of electrically conductive elements (e.g., 101) and the second row of electrically conductive elements (e.g., 102), the shield (e.g., 110) is spaced apart from the first row of electrically conductive elements (e.g., 101) and the second row of electrically conductive elements (e.g., 102) in the height direction, respectively, by a predetermined distance.

11. The electrical connector according to any one of aspects 7 to 9 or any other aspect, wherein the housing (e.g., 200) comprises an terminal assembly housing (e.g., 260), the terminal assembly housing (e.g., 260) defining a housing portion for accommodating the first terminal (e.g., 10) and the second terminal (e.g., 20), the tail portion (e.g., 12) of the first terminal (e.g., 10) and the tail portion (e.g., 23) of the second terminal (e.g., 20) are molded into the housing portion of the terminal assembly housing (e.g., 260) by injection molding.

12. The electrical connector according to aspect 11 or any other aspect, wherein the shield (e.g., 106) is molded into the housing portion of the terminal assembly housing (260) by injection molding together with the tail portions (e.g., 12) of the first terminals and the tail portions (e.g., 23) of the second terminals (e.g., 20) forming the first row of electrically conductive elements and the second row of electrically conductive elements.

13. The electrical connector according to aspect 7 or any other aspect, wherein the electrical connector further comprises a first sealing member (e.g., 300); and a groove (e.g., 210) is provided along a circumferential portion of the housing (e.g., 200), the first sealing member (e.g., 300) is provided inside the groove (e.g., 210).

14. The electrical connector according to aspect 13 or any other aspect, wherein the electrical connector further comprises a second sealing member (e.g., 400); and the housing (e.g., 200) is provided with a cavity (e.g., 220) having a hole depth direction perpendicular to a top surface of the terminal assembly (e.g., 100), and the second sealing member (e.g., 400) is provided inside the cavity (e.g., 220).

15. The electrical connector according to aspect 14 or any other aspect, wherein the housing (e.g., 200) is provided with a first rough portion (e.g., 230) at a groove bottom of the groove (e.g., 210), for increasing an adhesion force between the first sealing member (e.g., 300) and the housing (e.g., 200); and the terminal assembly (e.g., 100) is provided with a second rough portion (e.g., 240) in a region where the cavity (e.g., 220) is projected on the terminal assembly (e.g., 100) in the hole depth direction, for increasing an adhesion force between the second scaling member (e.g., 400) and the terminal assembly (e.g., 100).

16. The electrical connector according to aspect 13 or any other aspect, wherein the first sealing member (e.g., 300) is an elastically deformable member, the first sealing member (e.g., 300) is configured to elastically deform when the first sealing member (e.g., 300) contacts with a mounting portion of an electronic device adapted to the electrically connector, and to form an interference fit with the mounting portion of the electronic device.

17. The electrically connector according to aspect 13 or any other aspect, wherein the first sealing member (e.g., 300) is configured to have an annular shape extending continuously in a circumferential direction around a mating end of the housing (e.g., 200), the first scaling member (e.g., 300) is configured to have an attachment surface forming a positive fit with the groove (e.g., 210) of the housing (e.g., 200).

18. The electrical connector according to aspect 14 or any other aspect, wherein the second sealing member (e.g., 400) is configured to have a substantially square shape, the second scaling member (e.g., 400) is configured to have an attachment surface forming a positive fit with the cavity of the housing (e.g., 200).

19. The electrical connector according to aspect 14 or any other aspect, wherein the electrical connector further comprises a frame (e.g., 500); the frame (e.g., 500) has a first portion (e.g., 510) embedded in the housing (e.g., 200), a second portion (e.g., 520) disposed outside of the housing (e.g., 200), and a third portion (e.g., 530) formed by extending from both sides of the first portion (e.g., 510); and the housing (e.g., 200) is formed with a bracket (e.g., 250) extending from both sides thereof, the third portion (e.g., 530) of the frame (e.g., 500) is embedded in the bracket (e.g., 250).

20. The electrical connector according to aspect 19 or any other aspect, characterized in that an accommodating portion (e.g., 264) for accommodating the first portion (e.g., 510) is provided in the vicinity of a tail end of the terminal assembly housing (e.g., 260) such that the frame (e.g., 500) is positioned in a predetermined position relative to the terminal assembly housing (e.g., 260) and the terminal assembly (e.g., 100).

21. The electrical connector according to aspect 19 or any other aspect, wherein a central portion of the housing (e.g., 200) connecting the bracket (e.g., 250) is formed with the cavity (e.g., 220), and before the second sealing member (e.g., 400) is arranged in the cavity (e.g., 220), a corresponding ones of the first terminals (e.g., 10) and the second terminals (e.g., 20) are exposed through the cavity (e.g., 220).

22. The electrical connector according to aspect 21 or any other aspect, wherein a mating portion of the housing (e.g., 200) is formed with the groove (e.g., 210) at a predetermined position from the central portion.

23. A method for manufacturing an electrical connector according to any one of aspects 7 to 22 or any other aspect, wherein the method comprises: Step 01): providing a plurality of first terminals (e.g., 10) and a plurality of second terminals (e.g., 20), and forming a first row of electrically conductive elements (e.g., 101) by some of the plurality of first terminals (e.g., 10) and some of the plurality of second terminals (e.g., 20), and forming a second row of electrically conductive elements (e.g., 102) by the others of the plurality of first terminals (e.g., 10) and the others of the plurality of second terminals (e.g., 20); Step 02): providing a shield (e.g., 110); Step 03): placing the first row of electrically conductive elements (e.g., 101) and the shield (e.g., 110) into a first injection mold and performing a first injection molding to form a first molding member (e.g., M1); Step 04): assembling the second row of electrically conductive elements (e.g., 102) onto the first molding member (e.g., M1) and positioning the second row of electrically conductive elements (e.g., 102) in a predetermined position relative to the first molding member (e.g., M1); and Step 05): providing a frame (e.g., 500) and positioning the frame (e.g., 500) in a predetermined position relative the first molding member (e.g., M1) and the second row of electrically conductive elements (e.g., 102), placing the frame (e.g., 500), the second row of electrically conductive elements (e.g., 102), and the first molding member (e.g., M1) into a second injection mold, and performing a second injection molding to form a second molding member (e.g., M2) comprising a housing (e.g., 200).

24. The method according to aspect 23 or any other aspect, wherein in the Step 03), a mounting slot for assembling the second row of electrically conductive elements (e.g., 102) is integrally molded on a side of the first molding member (e.g., M1) opposite to a side of the shield (e.g., 110) positioning the first row of electrically conductive elements (e.g., 101).

25. The method according to aspect 24 or any other aspect, wherein the mounting slot comprises a plurality of first slots (e.g., 261) close to a mating end side of the first molding member (e.g., M1), a plurality of third slots (e.g., 263) close to a tail end side of the first molding member (e.g., M1), and a plurality of second slots (e.g., 262) provided between the plurality of first slots (e.g., 261) and the plurality of third slots (e.g., 263) in a mating direction (Y) of the electrical connector (e.g., 1), each of the plurality of first slots (e.g., 261), each of the plurality of second slots (e.g., 262) and each of the plurality of third slots (e.g., 263) are aligned with one another in a one-to-one correspondence in the mating direction (Y) of the electrical connector (e.g., 1), for housing and positioning a corresponding one of the terminals forming the second row of electrically conductive elements (e.g., 102).

26. The method according to aspect 23 or any other aspect, wherein the first molding member (e.g., M1) formed in the Step 03) comprises an terminal assembly housing (e.g., 260), with an accommodating portion (e.g., 264) provided on a side of the terminal assembly housing (e.g., 260) on which the first row of electrically conductive elements (e.g., 101) is arranged and near a tail end of the first molding member (e.g., M1).

27. The method according to aspect 26 or any other aspect, wherein in the Step 05), providing a frame (e.g., 500) comprises configuring the frame (e.g., 500) with: a first portion (e.g., 510) as a central portion of the frame (e.g., 500); a second portion (e.g., 520) extending from the first portion (e.g., 510) in the mating direction (Y) toward a tail end of the electrical connector (e.g., 1); and a third portion (e.g., 530) overhanging from both sides of the first portion (e.g., 510) in a width direction (X) of the electrical connector (e.g., 1) in a height direction (Z) of the electrical connector (e.g., 1), the third portion (e.g., 530) is formed with an L-shaped stepped portion having legs parallel to the first portion (e.g., 510), the second portion (e.g., 520) is accommodated in the accommodating portion (e.g., 264) to position the frame (e.g., 500) in a predetermined position relative to the first molding member (e.g., M1) and the second row of electrically conductive elements (e.g., 102) assembled together in the Step 04).

28. The method according to aspect 23 or any other aspect, wherein in the Step 05), during performing the second injection molding to form a second molding member (e.g., M2), a supporting portion (e.g., 270) is formed in the vicinity of a tail end of the housing (e.g., 200), wherein a groove (e.g., 210) is formed at a mating side of the supporting portion (e.g., 270) at a predetermined distance from the supporting portion (e.g., 270), and a cavity (e.g., 220) is formed on two opposite surfaces of the supporting portion (e.g., 270) in the height direction (Z) of the electrical connector (e.g., 1).

29. The method according to aspect 28 or any other aspect, wherein the method further comprises roughening the electrical connector, the groove (e.g., 210) and the cavity (e.g., 220) to form a rough portion.

30. The method according to aspect 29 or any other aspect, wherein the method further comprises: applying an adhesive at the rough portion of the groove and/or at the rough portion of the cavity to form a first sealing member (e.g., 300) in the groove and/or a second sealing member (e.g., 400) in the cavity.

31. The method according to aspect 23 or any other aspect, wherein in the Step 03), the first row of electrically conductive elements (e.g., 101) is spaced apart from the shield (e.g., 110) in the height direction (Z) of the electrical connector (e.g., 1).

32. The method according to claim 31, wherein in the Step 04), the second row of electrically conductive elements (e.g., 102) is positioned in a predetermined position relative to the first molding member (e.g., M1) in a manner that the second row of electrically conductive elements is spaced from the first row of electrically conductive elements (e.g., 101) in the height direction (Z) of the electrical connector (e.g., 1) and that the shield (e.g., 110) is located between the first row of electrically conductive elements (e.g., 101) and the second row of electrically conductive elements (e.g., 102).

33. A terminal assembly (e.g., 100) comprises a plurality of first terminals (e.g., 10) aligned in a row direction, each of the plurality of first terminals having a same thickness in a vertical direction perpendicular to the row direction along a length of the first terminal; and a plurality of second terminals (e.g., 20) aligned with the plurality of first terminals in the row direction, each of the plurality of second terminals comprising a portion (e.g., 21) with a smaller thickness in the vertical direction than a rest of the second terminal.

34. The terminal assembly of aspect 33 or any other aspect, wherein the plurality of first terminals are configured for transmitting power; and the plurality of second terminals are configured for transmitting signals.

35. The terminal assembly of aspect 34 or any other aspect, wherein the terminal assembly is configured according to the USB-C standard; each of the plurality of first terminals is configured to convey a current in a range of 5 A to 10 A; and each of the plurality of second terminals is configured to transmit signals at a speed in a range of 5 Gbps to 80 Gbps per second.

36. The terminal assembly of aspect 33 or any other aspect, wherein each of the plurality of first terminals has a first thickness in a range of 0.1 mm to 0.35 mm; and for each of the plurality of second terminals: the portion with the smaller thickness has a thickness in a range of 0.01 mm to 0.10 mm, and the rest of the second terminal has a thickness in a range of 0.1 mm to 0.25 mm.

37. The terminal assembly of aspect 33 or any other aspect, wherein each of the plurality of second terminals comprises a mating portion configured for mating with another component, and the mating portion of the second terminal comprises the portion with the smaller thickness.

38. The terminal assembly of aspect 37 or any other aspect, wherein each of the plurality of second terminals comprises a tail portion opposite the mating portion and configured for surface mounting to a board.

39. The terminal assembly of aspect 38 or any other aspect, wherein each of the plurality of first terminals and the plurality of second terminal comprises a plating layer of one or more of platinum, rhodium-ruthenium, and palladium.

40. The terminal assembly of aspect 38 or any other aspect, wherein each of the plurality of first terminals and the plurality of second terminals comprises a rough portion (e.g., 240) adjacent the tail portion, and the rough portion of the respective terminal has a surface roughness higher than other portions of the respective terminal such that a sealing member can be attached to the rough portions of the terminals.

41. An electrical connector comprises a housing comprising a body, a tongue extending from the body in a mating direction, and a bracket extending from a side of the body; a plurality of conductive elements held by the housing in a row, each of the plurality of conductive elements comprising a mating portion held by the tongue of the housing and a tail portion extending out of the housing; and a frame (e.g., 500) comprising a first portion (e.g., 510) embedded in the body of the housing, a second portion (e.g., 520) disposed outside the housing, and a third portion (e.g., 530) embedded in the bracket (e.g., 250) of the housing.

42. The electrical connector of aspect 41 or any other aspect, wherein the housing comprises a groove (e.g., 210) disposed between the body and the tongue and having a surface with a roughness higher than other portions of the housing; and a sealing member (e.g., 400) is attached to the surface of the groove of the housing.

43. The electrical connector of aspect 42 or any other aspect, wherein the groove is disposed along a circumferential portion of the housing.

44. The electrical connector of aspect 42 or any other aspect, wherein the bracket is a first bracket extending from a first side of the body of the housing; the housing comprises a second bracket extending from a second side of the body of the housing opposite the first side; and the sealing member is disposed between the first and second brackets.

45. The electrical connector of aspect 44 or any other aspect, wherein each of the first and second brackets comprises a hole; and the third portion of the frame comprises holes aligned with the holes of the first and second brackets.

46. The electrical connector of aspect 42 or any other aspect, wherein the sealing member is a first sealing member; the body of the housing comprises a cavity (e.g., 220); and the electrical connector comprises a second sealing member (e.g., 300) disposed in the cavity of the body of the housing and attached to portions of the plurality of conductive elements passing the cavity of the body of the housing.

47. The electrical connector of aspect 42 or any other aspect, wherein the portions of the plurality of conductive elements passing the cavity of the body of the housing have surfaces with a roughness higher than other portions of respective conductive elements.

48. The electrical connector of aspect 41 or any other aspect, wherein the plurality of conductive elements comprise first terminals (e.g., 10) each having a uniform thickness along its length and second terminals (e.g., 20) having a smaller thickness at the mating portion than the tail portion.

49. A method for manufacturing an electrical connector comprises providing a plurality of conductive elements; molding an assembly housing (e.g., 260) over at least portions of the plurality of conductive elements (e.g., 10, 20); disposing a frame (e.g., 500) on the assembly housing; and molding a connector housing (e.g., 200) over a portion of the frame.

50. The method of aspect 49 or any other aspect, wherein the plurality of conductive elements is a first plurality of conductive elements aligned in a first row; and the method comprises disposing a second plurality of conductive elements in a second row parallel to the first row before disposing the frame on the assembly housing.

51. The method of aspect 49 or any other aspect, wherein the connector housing comprises a groove (e.g., 210) around a circumferential direction of the connector housing; and the method comprises: roughening a surface of the groove of the housing, and forming a scaling member (e.g., 400) in the groove of the housing.

52. The method of aspect 51 or any other aspect, wherein the sealing member is a front sealing member; the housing comprises a cavity (e.g., 220) through which the plurality of conductive elements pass; and the method comprises forming a rear sealing member (e.g., 300) in the cavity of the housing and around the plurality of conductive elements pass therethrough.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A terminal assembly comprising:
a plurality of first terminals aligned in a row direction, each of the plurality of first terminals having a same thickness in a vertical direction perpendicular to the row direction along a length of the first terminal; and
a plurality of second terminals aligned with the plurality of first terminals in the row direction, each of the plurality of second terminals comprising a portion with a smaller thickness in the vertical direction than a rest of the second terminal.

2. The terminal assembly of claim 1, wherein:
the plurality of first terminals are configured for transmitting power; and
the plurality of second terminals are configured for transmitting signals.

3. The terminal assembly of claim 2, wherein:
the terminal assembly is configured according to the USB-C standard;
each of the plurality of first terminals is configured to convey a current in a range of 5 A to 10 A; and
each of the plurality of second terminals is configured to transmit signals at a speed in a range of 5 Gbps to 80 Gbps per second.

4. The terminal assembly of claim 1, wherein:
each of the plurality of first terminals has a first thickness in a range of 0.1 mm to 0.35 mm; and
for each of the plurality of second terminals:
the portion with the smaller thickness has a thickness in a range of 0.01 mm to 0.10 mm, and
the rest of the second terminal has a thickness in a range of 0.1 mm to 0.25 mm.

5. The terminal assembly of claim 1, wherein:
each of the plurality of second terminals comprises a mating portion configured for mating with another component, and the mating portion of the second terminal comprises the portion with the smaller thickness.

6. The terminal assembly of claim 5, wherein:
each of the plurality of second terminals comprises a tail portion opposite the mating portion and configured for surface mounting to a board.

7. The terminal assembly of claim 6, wherein:
each of the plurality of first terminals and the plurality of second terminal comprises a plating layer of one or more of platinum, rhodium-ruthenium, and palladium.

8. The terminal assembly of claim 6, wherein:
each of the plurality of first terminals and the plurality of second terminals comprises a rough portion adjacent the tail portion, and the rough portion of the respective terminal has a surface roughness higher than other portions of the respective terminal such that a sealing member can be attached to the rough portions of the terminals.

9. An electrical connector comprising:
a housing comprising a body, a tongue extending from the body in a mating direction, and a bracket extending from a side of the body;
a plurality of conductive elements held by the housing in a row, each of the plurality of conductive elements comprising a mating portion held by the tongue of the housing and a tail portion extending out of the housing; and
a frame comprising a first portion embedded in the body of the housing, a second portion disposed outside the housing, and a third portion embedded in the bracket of the housing.

10. The electrical connector of claim 9, wherein:
the housing comprises a groove disposed between the body and the tongue and having a surface with a roughness higher than other portions of the housing; and
a sealing member is attached to the surface of the groove of the housing.

11. The electrical connector of claim 10, wherein:
the groove is disposed along a circumferential portion of the housing.

12. The electrical connector of claim 10, wherein:
the bracket is a first bracket extending from a first side of the body of the housing;
the housing comprises a second bracket extending from a second side of the body of the housing opposite the first side; and
the sealing member is disposed between the first and second brackets.

13. The electrical connector of claim 12, wherein:
each of the first and second brackets comprises a hole; and
the third portion of the frame comprises holes aligned with the holes of the first and second brackets.

14. The electrical connector of claim 10, wherein:
the sealing member is a first sealing member;
the body of the housing comprises a cavity; and
the electrical connector comprises a second sealing member disposed in the cavity of the body of the housing and attached to portions of the plurality of conductive elements passing the cavity of the body of the housing.

15. The electrical connector of claim 10, wherein:
the portions of the plurality of conductive elements passing the cavity of the body of the housing have surfaces with a roughness higher than other portions of respective conductive elements.

16. The electrical connector of claim 9, wherein:
the plurality of conductive elements comprise first terminals each having a uniform thickness along its length and second terminals having a smaller thickness at the mating portion than the tail portion.

17. A method for manufacturing an electrical connector comprising:
providing a plurality of conductive elements;
molding an assembly housing over at least portions of the plurality of conductive elements;
disposing a frame on the assembly housing; and
molding a connector housing over a portion of the frame.

18. The method of claim 17, wherein:
the plurality of conductive elements is a first plurality of conductive elements aligned in a first row; and
the method comprises disposing a second plurality of conductive elements in a second row parallel to the first row before disposing the frame on the assembly housing.

19. The method of claim 17, wherein:
the connector housing comprises a groove around a circumferential direction of the connector housing; and
the method comprises:
roughening a surface of the groove of the housing, and
forming a sealing member in the groove of the housing.

20. The method of claim 19, wherein:
the sealing member is a front sealing member;
the housing comprises a cavity through which the plurality of conductive elements pass; and
the method comprises forming a rear sealing member in the cavity of the housing and around the plurality of conductive elements pass therethrough.
